(19) United States
(12) Patent Application Publication
(10) Pub. No.: US 2002/0027124 A1
(43) Pub. Date: Mar. 7, 2002

(54) Bio-mediated assembly of micrometer-scale and nanometer-scale structures

(76) Inventors: Rashid Bashir, West Lafayette, IN (US); Donald E. Bergstrom, West Lafayette, IN (US); Sangwoo Lee, West Lafayette, IN (US); Helen McNally, West Lafayette, IN (US); Dong Guo, West Lafayette, IN (US); John P. Denton, West Lafayette, IN (US); Maneesh Pingle, West Lafayette, IN (US)

Correspondence Address: Timothy N. Thomas, Woodard, Emhardt, Naughton, Moriarty and McNett, Bank One Center/Tower, 111 Monument Circle, Suite 3700, Indianapolis, IN, 46204-5137, US

(21) Appl. No.: 09/878,487

(22) Filed: Jun. 11, 2001

Related U.S. Application Data
(60) Provisional application No. 60/210,696, filed on Jun. 9, 2000.

(51) Int. Cl. B44C 1/22

(52) U.S. Cl. 216/11

(57) ABSTRACT

A method of assembling a nanometer-scale construct by:

(a) providing a nanometer-scale object such as an active electron device;

(b) attaching a first bio-link to said nanometer-scale object to form a functionalized nanometer-scale object;

(c) providing a substrate;

(d) attaching a second bio-link to said substrate to form a functionalized substrate, wherein said second bio-link is a complement to said first bio-link in that said second bio-link selectively binds with said first bio-link; and

(e) bringing said functionalized nanometer-scale object within close enough proximity of said functionalized substrate that said second bio-link selectively binds with said first bio-link, and thereby forms an assembled nanometer-scale construct.

The present invention relates generally to the assembly of nanometer-scale structures such as ultra dense integrated circuits, and more particularly to methods of using biological components such as DNA and ligands/receptors to mediate that assembly, including the heterogeneous integration of materials such as silicon on plastics.

### BACKGROUND OF THE INVENTION

Since the invention of the junction transistor in 1947 and the subsequent invention of the integrated circuit, the complexity of microelectronic integrated circuits and devices has increased exponentially. To accommodate that increased complexity, the components have become increasing miniaturized so that a more complex device can be provided in an ever-shrinking space. For example, the minimum feature size has decreased from 2 um in 1980 to 0.13 um in 2001 in volume production.

In recent years though, it has become increasingly difficult to continue to down-scale electronic devices due to real physical limitations such as the size of atoms, the wavelengths of radiation used for lithography, interconnect schemes, etc. Accordingly, as the construction of artificial computational systems continues to become insurmountably difficult, engineers and scientists must look to new and unconventional assembly methods for potential answers.

One avenue for increased miniaturization is to employ the sophisticated and complicated molecular systems that occur in nature. Such systems are often high-density, are self-assembled, sense and relay information, and perform complex computational tasks.

For example, the human brain has about 10¹¹ neurons in a volume of about 15 cm³. While the total number of transistors on a 2-dimensional chip is expected to reach that number by about year 2010, it is the 3-dimensional nature and interconnections of human neurons that makes the exquisite functions of the brain possible. So even though humans have achieved or will soon achieve a similar density of basic computational elements to that of brain, the replication of brain functions are far from reality.

Similarly, the case of DNA is also far-reaching and intriguing. The human DNA is about 6 mm long, has about 2×10 8 nucleotides and is tightly packed in a volume of 500 um³. If a set of three nucleotides can be assumed to be analogous to a byte (since a 3 codon set from mRNA is used to produce an amino acid), then these numbers represents about 1Kb/um (linear density) or about 1.2Mb/um 3 (volume density). These numbers are not truly quantitative but can give an appreciation of how densely stored information is in the DNA molecules. Certainly, a memory chip based on DNA as the active elements could have extremely high density.

In view of the above there has been a tremendous interest in the recent years to develop concepts and approaches for self-assembled systems for electronic and optical applications. See, e.g., J. Chen, M. A. Reed, A. M. Rawlett and J. M. Tour, Science, 286, 1550, 19 Nov. 1999; Kasibhatla, A. P. Labonte, S. Datta, R. Reifenberger and C. P. Kubiak, Science, in publication. As a result of that interest, material self-assembly has been demonstrated in a variety of semiconductor materials (GaAs, InSb, SiGe, etc) using Stranksi-Krastanov strain-dependent growth of lattice mismatch epitaxial films. See, e.g., A. Madhukar, Q. Xie, P. Chen, and A. Konkar, Appl. Phys. Lett., 64, 20, 16^{th} May, 2727 (1994); T. I. Kamins, E. C. Carr, R. S. Williams, and S. J. Rosner, J. Appl. Phys., 81 (1), 1st January, 211 (1997); R. Bashir, A. E. Kabir, and K. Chao, Applied Surface Science, 152, 99 (1999); A. Balandin, G. Jin, and K. L. Wang, Journal of Electronic Materials, 29, (5), (2000), p. 549. Also, fluidic self assembly of high-density devices has been developed. See, e.g., J. Smith, High Density, Low Parasitic Direct Integration by Fluidic Self Assembly, IEDM 2000 Proceedings, pp.201-204.

While significant work continues along that direction, it has also been recognized by engineers, chemists, and life scientists that the exquisite molecular recognition of various natural biological materials can also be used for a variety of optical, electronic, and sensing applications. This approach can be considered a ‘bottom-up’ approach rather than the ‘top-down’ approach of conventional scaling and much work has been reported towards this front.

Pioneering research extending over a period of more than 15 years by N. C. Seeman has laid a foundation for the construction of structures using DNA as scaffolds, which may ultimately serve as frameworks for the construction of nanoelectronic devices. See, N. C. Seeman, Nanotechnology, 149, (1991); N. C. Seeman, Annual Rev. Biophys. Biomol. Struc. Vol. 27, 225 (1998).

Among the roles envisioned for nucleic acids in nanoelectronic devices, the self-assembly of DNA conjugated nano-particles has received the most attention in recent literature. For example, Mirkin et al. and Alivisatos et al. were the first to describe self-assembly of gold nano-clusters into periodic structures using complementary strands of DNA. See, C. A. Mirkin, R. L. Letsinger, et al, Nature, Vol. 382, 15^{th} August, 607 (1996); A. P. Alivisatos, K. P. Johnsson, et al, Nature, Vol. 382, 15^{th} August, 609 (1996). Later, the DNA-inspired self-assembly of optical and opto-electronic components onto a host substrate was proposed by Heller and co-workers, but that concept was not reduced to practice. See, D. E. Ackley, et al., Proceedings-Lasers and Electro-Optics Society, Annual Meeting-LEOS, vol 1, 85 (1998).

In addition to the above, there are many applications where it is desirable to assemble silicon-based electronic components onto non-silicon-based substrates such as plastics. For example, current LCD technology is constrained by the use of glass as a substrate and the semiconductor amorphous-Silicon (a-Si). While other semiconductor materials are used in ICs, such as Gallium Arsenate and Single Crystalline Silicon (s-Si), a-Si is used in LCDs because it can be economically applied through a complex process to suitable display substrates, such as glass or plastics. However, the use of plastic substrates has been infeasible to date because the amorphous silicon layer requires extensive processing involving high temperatures, typically between 350-600 C. Plastic substrates with the proper optical properties cannot withstand temperatures above 150 C.

Unfortunately, glass is expensive, fragile, and inflexible. In addition, a-Si, which is converted to polycrystalline Silicon (p-Si) during LCD manufacture, has lower electron mobility and requires high voltages than other semiconductors. Thus, its use hinders display performance and prevents the integration of driver circuitry logic on the substrate.

In view of the above it can be seen that there is a need for practical techniques for utilizing biological molecules to assemble nanometer-scale objects onto substrates, and particularly onto heterogeneous substrates such as plastics. The present invention addresses that need.

### SUMMARY OF THE INVENTION

Briefly describing one aspect of the present invention, there is provided a method of assembling a nanometer-scale construct by:

(a) fabricating a nanometer-scale active electron device;

(b) attaching a first bio-link to said nanometer-scale active electron device to form a functionalized nanometer-scale active electron device;

(c) providing a substrate;

(d) attaching a second bio-link to said substrate to form a functionalized substrate, wherein said second bio-link is a complement to said first bio-link in that said second bio-link selectively binds with said first bio-link; and

(e) bringing said functionalized nanometer-scale active electron device within close enough proximity of said functionalized substrate that said second bio-link selectively binds with said first bio-link, and thereby forms an assembled nanometer-scale construct.

One object of the present invention is to provide an improved method for assembling nanometer-scale objects onto a substrate, with biological molecules being used as a “molecular glue.”

Other objects and advantages will be apparent from the following description.

### BRIEF DESCRIPTION OF THE DRAWINGS

FIG. 1 shows the preferred process flow of one embodiment of the present invention.

FIG. 2 shows the fabrication of releasable electron devices in silicon, according to one embodiment of the present invention.

FIG. 3 shows another process flow of a preferred embodiment of the present invention.

FIG. 4 shows a method for releasing fabricated objects.

FIG. 5 shows SEMs of the silicon islands of one preferred embodiment of the present invention.

FIG. 6 shows box plots of gold surface roughness data.

FIG. 7 shows a schematic of a sulfide linkage for attaching biolinks to an object or substrate.

FIG. 8 shows a three-arm thiol linker for attaching oligonucleotides to a substrate such as gold.

FIG. 9 shows a six-arm alkene linker for attaching oligonucleotides to a substrate such as platinum.

FIG. 10 shows a three-arm pyrene linker for attaching oligonucelotides to a substrate such as carbon.

FIG. 11 shows possible 2D interconnect schemes for assembly and docking of objects on a substrate.

FIG. 12 shows possible 3D interconnect schemes for assembly and docking of objects on a substrate.

FIG. 13 shows the inter-digitated finger structure of metal electrodes used for electrostatic positioning of objects.

FIGS. 14-15 are optical micrographs if the inter-digitated electrode array with the micro-scale charged objects.

FIGS. 16-19 are optical micrographs if the inter-digitated electrode array with the micro-scale charged objects, showing movement of the charged objects upon the application and subsequent reversal of the voltage polarity.

FIG. 20 shows one strategy for association of oligonucleotide-conjugated surfaces.

FIG. 21 shows direct and indirect hybridization of DNA strands to attach an object to a substrate.

FIG. 22 shows a recessed gold pattern within an insulator as used for verification of assembly and docking.

FIG. 23 shows test structures and device attachment schemes for the bar case (a) and shape-mediated case (b) FIG. 24 shows the biotin and avidin biolinks.

### DESCRIPTION OF THE PREFERRED EMBODIMENTS

For the purposes of promoting an understanding of the principles of the invention, reference will now be made to certain preferred embodiments and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

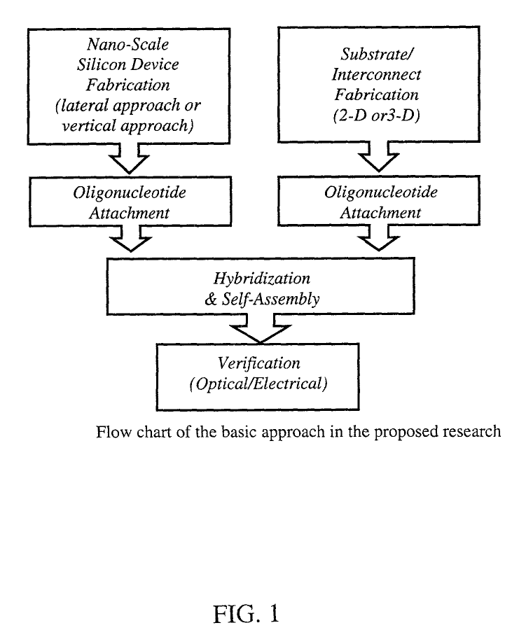

As indicated above, one aspect of the present invention relates generally to methods for assembling nanometer-scale constructs using biomolecules such as nucleic acids (particularly DNA), proteins, polysaccharides, etc., as linking agents. Two “complementary” biomolecules (i.e., biomolecules that selectively bind together) are used. One of the biomolecules is attached to a nanometer-scale object, and the other biomolecule is attached to a desired substrate. The two pieces are moved close enough together that the complementary nature of the two biomolecules causes the pieces to bind together, thereby assembling the nano-scale object onto the substrate. FIG. 1 shows the preferred process using oligonucleotides as the biolinking molecules.

For the purpose of this disclosure, nanometer-scale objects are defined as objects having a mass that is less than the mass of a silicon cube 10 microns on each side (i.e., less than about 3×10⁻⁹ gm). More preferably, the nanometer-scale objects will have a mass that is less than about 1×10⁻⁹ gm, and most preferably the nanometer-scale objects will have a mass that is less than about 1×10⁻¹⁰ gm.

1. Preparing/Fabricating the Nanometer-Scale Object.

In some embodiments the nanometer-scale object that is to be attached to the substrate is a fabricated device. For example, active electronic components such as transistors, resistors, capacitors, and diodes may be fabricated and attached, as may optical components such as LEDs, lasers, protovoltic devices, etc. Micro-scale sensors and micro-electro mechanical systems (MEMS) and sensors may also be fabricated and attached. All of these may be provided with or without integrated circuit interconnects.

In most embodiments the devices are released (typically by etching the underlying layer) from the substrate and are collected and contained in solution. There can be thousands or even millions of the devices suspended or contained in the solution media.

One technique for fabricating the nano-scale structure is to use selective epitaxial growth of semiconductors combined with chemical-mechanical polishing. In that method a silicon substrate is provided with an oxide layer, and a recess is created within that oxide layer using photolithography and an oxide-etch step. Subsequently, a seed hole region is created close to the oxide recess and a selective semiconductor material (e.g., a single crystal silicon) is grown vertically and laterally from the seed hole, filling the seed hole and the oxide recess region. Selective epitaxial growth (SEG) or epitaxial lateral overgrowth (ELO) techniques are preferred for growing the semiconductor material. See, e.g., R. Bashir, T. Su, J. M. Sherman, G. W. Neudeck, J. Denton, and A. Obeidat “Reduction of Sidewall Defect Induced Leakage Currents by the Use of Nitrided Field Oxides in Silicon Selective Epitaxial Growth (SEG) Isolation for Advanced ULSI”, Journal of Vacuum Science and Technology-B, Vol. 18, No. 2, March/April 2000.

A chemical-mechanical polishing step is used to planarize the overgrown semiconductor material (silicon), using the oxide as an etch stop. This forms a local SOI region that can be removed by etching the underlying oxide layer laterally. In some embodiments the lateral etch proceeds only until a thin connector pedestal connecting the SOI to the substrate remains. The connector pedestal can be broken by agitation such as ultrasonic vibration.

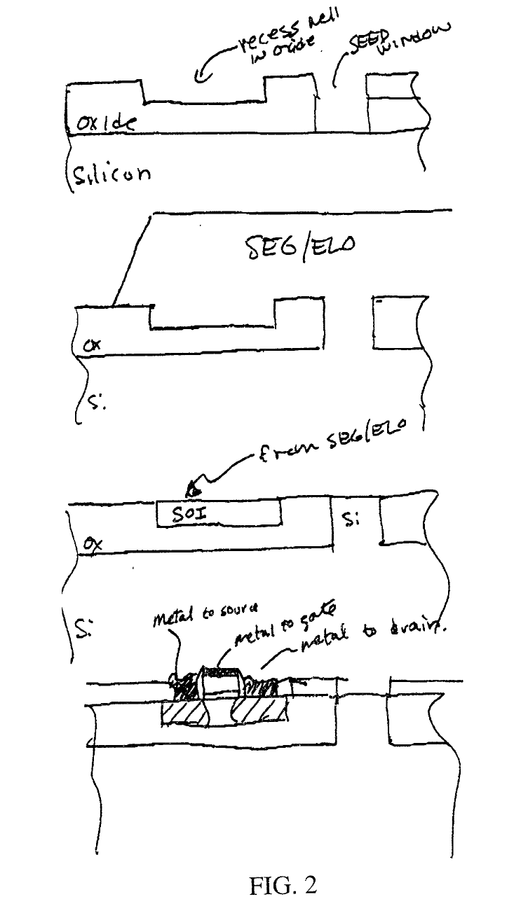

FIG. 2 shows one embodiment of the above process. A seed window and a recess in the oxide layer are provided as shown in FIG. 2(a). Selective silicon is grown from a seed hole adjacent to the recessed region and fills the oxide recess as shown in 2(b). Chemical/mechanical polishing is used to remove excess silicon, using the oxide as the etch stop to form thin nano-scale SOI (silicon on insulator) device islands as shown in FIG. 2(c). Metal layers connect to the source, drain, and gate, as shown in FIG. 2(d).

Electron-beam lithography may be used to define the size of the islands with any of the above techniques. In one embodiment an e-beam lithography direct write system is used for the definition of the nanoscale device regions. Alternatively, techniques to pattern large arrays of uniform sized patterns can be used.

In some embodiments a photoresist mask is used to implant and form a P/N junction diode within the device island. The planarized device islands can be patterned with an Au (and/or Pt or some other suitable metal) layer using e-beam lithography. All the oxide from the wafers is then etched to release the device islands into a liquid ambient.

Using the described process, fabricated SOI islands that are about 150 nm X 150 nm have been prepared. The quality of these islands has been excellent, as tested by fabricating MOSFETs in these islands. The polished surface of these silicon islands is as smooth as prime silicon wafer i.e. the rms roughness is less than 5Å FIG. 5 shows a top view SEM of some fabricated SOI islands.

### EXAMPLE 1

### Fabrication Process

Bonded Etched-Back Silicon-on-Insulator (BESOI) wafers may be used for the formation of the devices. These substrates are commercially available and are naturally suited for use in the present invention due to the presence of the buried oxide etch stop.

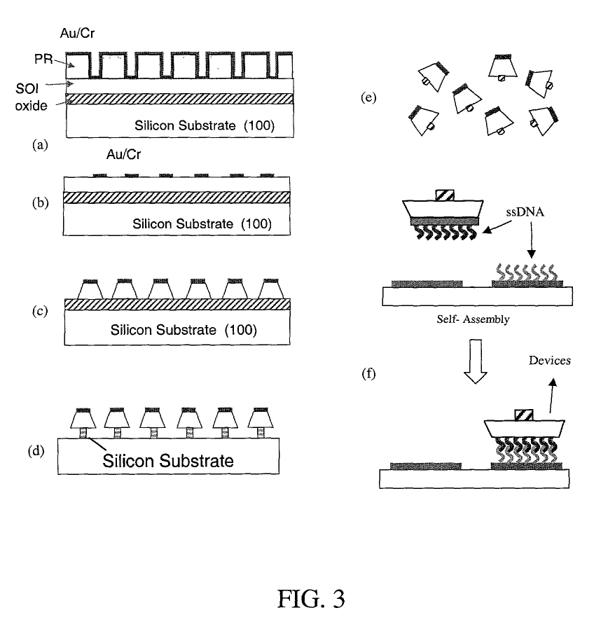

FIG. 3 depicts one possible process flow. The fabrication starts with commercially available wafers with silicon on an oxide layer. The wafer typically has a 0.1 μm to 10 μm top silicon layer and a 0.1 μm to 1 μm oxide thickness.

A lift-off process is used to define the desired metal patterns on the surface of the silicon layer. Photoresist patterns with 4 μm×4 μm open windows are then defined on the wafers. The size of the islands can be varied as desired by selecting an appropriate exposure tool.

The surface of the silicon is etched in buffered hydrofluoric acid solution for 5 seconds prior to loading the samples in a thermal evaporator. 50Å to 300Å of chromium and 50Å to 500Å of gold is then sequentially deposited as shown in FIG. 3(a). The chromium layer acts as an adhesion layer between gold and silicon, and is also resistant to the etchants used later in the process.

The wafers are then soaked in acetone until the resist is removed and the patterns of Au/Cr are formed, as shown in FIG. 3(b). Next, the silicon is etched using a wet potassium hydroxide (KOH) solution using the Au/Cr layer as a mask. The etch solution consists of 30 g of KOH, 250 ml of DI water, and 80 ml of isopropyl alcohol. A temperature of about 55° C. (±1° C.) is used, and the silicon etch rate is preferably about 0.13 μm/min. The SOI layer etches off in about 20 minutes, as shown in FIG. 3(c).

The next step is to etch the oxide and release the islands into a medium of DI water or ethanol so that the biolink attachment can take place. Since the buried oxide is etched in BHF solution, the islands must be collected. A number of different processes can be used. First, the entire oxide can be etched off in BHF, however, in this case, the islands may float off in the acidic solution and will then need to be then filtered and transferred into a solvent. During this process, prolonged exposure of the acid to the metal could cause damage if pin-holes or other defects are present in the metal films. In addition, the filtration and separation apparatus also needs to be acid proof, and hence this process is not generally preferred.

One option is to attach substrates (from topside) to another substrate using black wax. Next the buried oxide is etched laterally using BHF solution and the islands, which are attached to the black wax, are transferred to the other substrate. The black wax is then dissolved away in acetone and the islands are hence transferred to the solvent. This process is also not very convenient since it requires a very long BHF etch for the lateral oxide etch (up to 10 hours for a 5″ wafer).

In the most preferred embodiments a new process, shown in FIG. 3(d), is used. In this process a buried oxide is partially etched in BHF so that that islands are still connected to the substrate by relatively thin connector pillars. At this point, the wafers are moved from the BHF solution to DI water or acetone and then placed in an ultra-sonic agitator. If the aspect ratio of the oxide connector pillar is less than one, then the pillar breaks off during the agitation step and the islands are released from the substrate into the ambient solution. Best results are achieved when the ultrasonic frequency is the same as the resonant frequency of the object to be released.

The resulting solution with islands is now ready to be used for biolink molecule attachment. The solution can also be centrifuged if necessary to concentrate the islands. Although some islands may still be lost due to reattachment to the substrate or sticking to the wall of the container, about 10⁴ to 10⁵ islands/ml of DI solution have reliably been collected in testing to date.

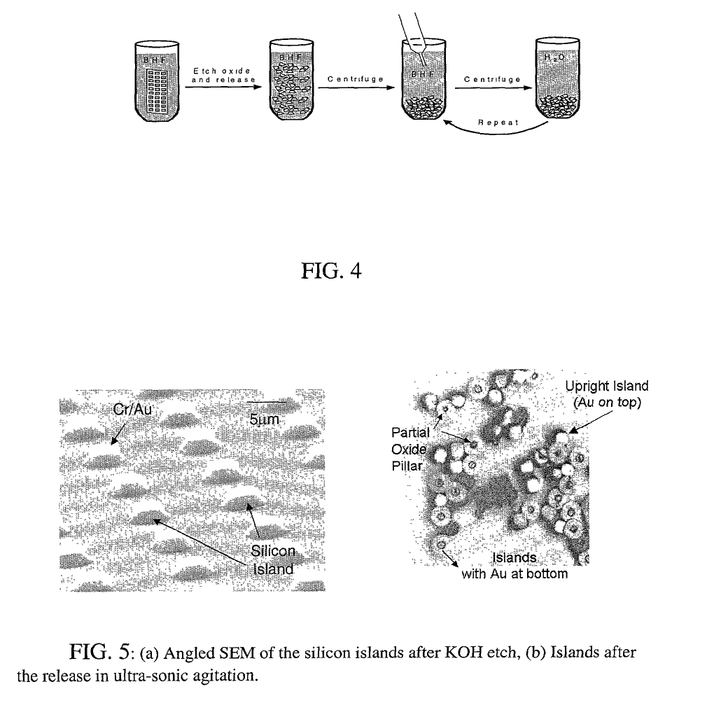

Another release process is depicted in FIG. 4. This process relies on centrifugation and re-suspension of the islands in an increasingly diluted solution of HF to eventually transfer the islands to DI water. The process suffers from low yield though, and hence is not preferred for most applications.

### EXAMPLE 2

### Fabrication Results

FIG. 5(a) shows scanning electron micrograph pictures of fabricated silicon islands before they were released. The KOH produces smooth angled sidewalls (at 54.7°) due to the anisotropic etch of the (100) crystal plane of the SOI layer. The Au/Cr layer is also intact after the KOH etch. A titanium layer, instead of the chromium layer, would also act as a good adhesion layer between the Au and silicon, but does not withstand the KOH and BHF etch solutions very well, and hence is not preferably used. FIG. 5(b) shows a top view optical picture of the islands after they have been released and placed on another clean wafer.

Device release can be verified using optical or scanning electron microscopy. The devices can then be transferred to another beaker for oligonucleotide functionalization (described in later sections). It is important to note that using this lateral approach the devices can be formed with arbitrary shapes and sizes, limited in the lateral dimension by e-beam lithography. The vertical dimension i.e. thickness can be much thinner (as low as 100A) since controlled oxidation can be used to make the islands thinner subsequent to the polishing.

It is important to appreciate that when a metal film is provided on the nano-scale object the surface of the metal film should be smooth prior to the attachment of the DNA molecules. In particular, peak-to-valley distance of “protrusions” in the metal film should be larger than the length of the molecule to be used.

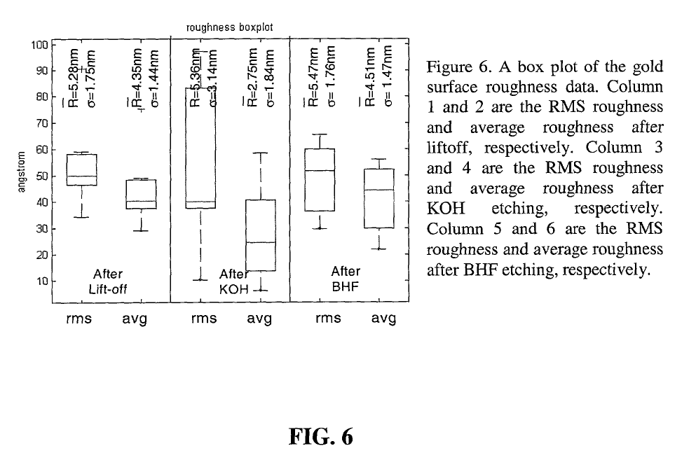

Atomic force microscopy (AFM) may be used to characterize the roughness of the gold surface along one of the fabrication process. Contact mode AFM images shows the silicon island's surface condition after each fabrication step. As shown in FIG. 6, gold surface roughness data of the silicon islands show that the evaporated gold surface roughness was below 6 nm. Though the KOH etching process increased the gold surface roughness, the gold surface roughness after the final BHF etching process was still in the range from 2 nm to 7 nm. Smoothing of the surface following BHF etching may be surprising. However, it is well known that isotropic or wet etching of surfaces can actually result in the smoothing of rough regions and protrusions.

2. Attaching the BioLink to the Nano-Scale Object.

Once the nanometer-scale objects are provided, each of the objects is “functionalized” by attaching a first biomolecule to the objects. As indicated above, the first biomolecule will be used to help link the object to the substrate, so it must have a second biomolecule that is a complement so that the two biomolecules can bind together to attach the object to the substrate. It is understood that a plurality of “first” biomolecules and “second” biomolecules are used to attach a plurality of objects to one or more substrates, with at least one “first” biomolecule being used to attach each object to a substrate.

In certain preferred embodiments the two biomolecules are nucleic acids, and most preferably are single strands of DNA that will hybridize to form the required link. Alternatively or additionally, proteins, polysaccharides, or other natural or synthetic monomers or polymers may also be used.

The biomolecules cooperate as a “lock and key” to selectively bind together. In some embodiments the linking is direct, i.e., one biomolecule to the other, while in other embodiments the linking is indirect, i.e., each biomolecule links to a third molecule which completes the link.

In one preferred embodiment one of the biolink molecules is a ligand such as biotin, and the other biolink molecule is a receptor such as avidin or streptavidin. These biolink molecules are attached to the object and the substrate, and will selectively bind to “glue” the two pieces together.

Frequently the object to be attached is an electrical device such as a MOSFET, and has gold as a contact to the source, drain, etc. In that case the biolink (e.g., DNA or multiple DNA's to multiple sites) is preferably attached to the gold surface of the object through a thiol (sulfohydrol) by forming a covalent thiolate bond between the sulfur and the gold. In particular, a long chain ω-substituted dialkyldisulfide molecule may be bound to a gold surface on a nano-scale object using this type of connection. Long-chain thiols of the formula: HS(CH2)nX (where X is the end group) are preferably used.

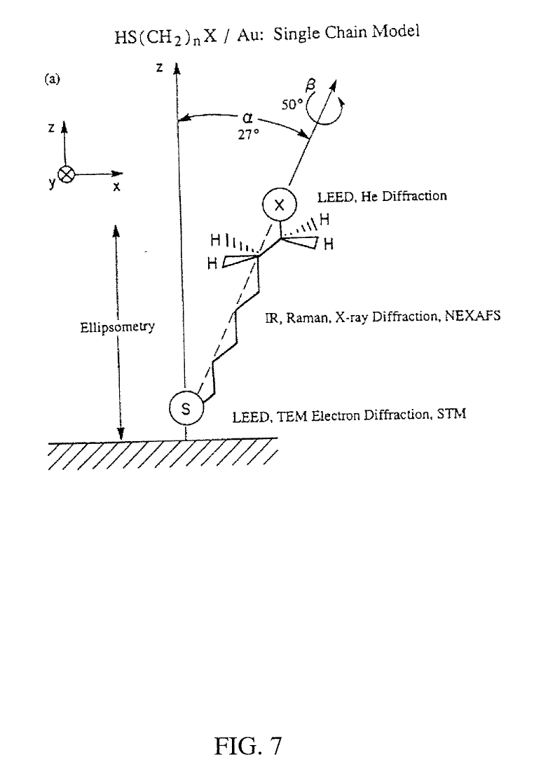

The schematic of the Au-S bond is shown in FIG. 7. The bonding of the sulfur head group to the gold substrate is in the form of a metal thiolate, which is a very strong bond (˜44 kcal/mol) and hence the resulting films are quite stable and very suitable for surface attachment of functional groups. For example, a DNA molecule can be functionalized with a thiol (S-H) or a disulfide (S-S) group at the 3′ or 5′ end.

Upon immersion of clean gold surfaces in solutions of thiol derivatized oligonucleotides, the sulfur adsorbs on the gold surfaces forming a single layer of molecules, where the hydrocarbon is now replaced with a ssDNA or a dsDNA molecule. This selective and orthogonal self-assembly of disulfide with gold and isocyanide with platinum finds particular utility with the materials and methods of the present invention, and especially in the self-assembly of structures that have both platinum and gold surfaces exposed for functionalization. Hence, the thiol-based chemistry is a preferred attachment scheme for DNA and oligonucleotides for the self-assembly of artificial nano-structures.

The biolink is introduced to the solution containing the objects to be assembled, and attaches to all of the devices. This provides a solution of electronic devices (e.g., MOSFETS) with a biolink (e.g., ssDNA) attached to each one.

It is important that only one end of the biolink molecule attach to the object to be assembled, with the other end of the biolink molecule being free for attachment to another site. Accordingly, the two ends of the molecule must be able to distinguish between different types of material or “flavors” of materials. For example, if both ends of the molecule “like” pure gold, then the molecule will create a chain of electron devices in the solution and will not create discrete devices. The ideal molecule has a “selectivity” for bonding to specific materials.

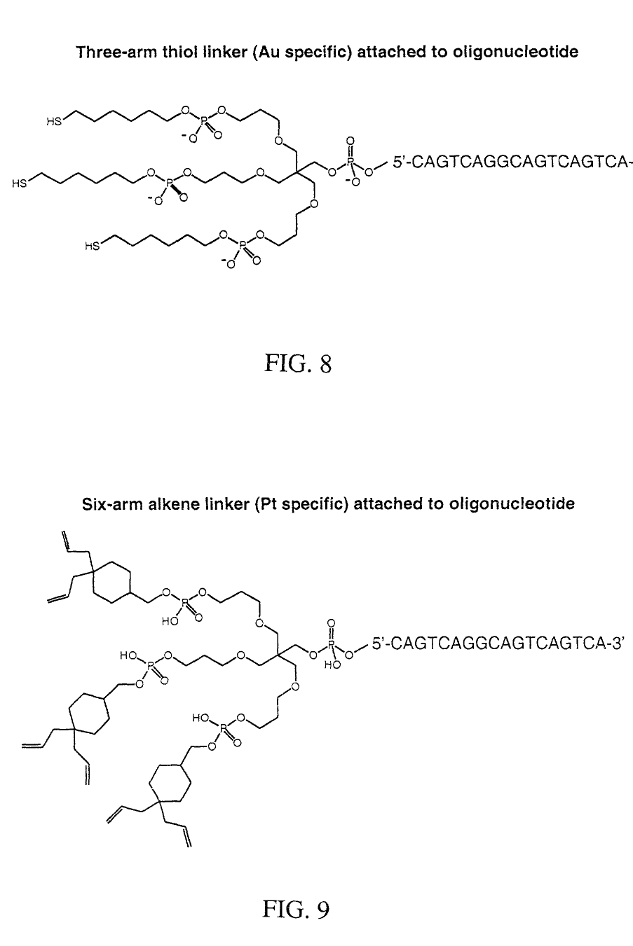

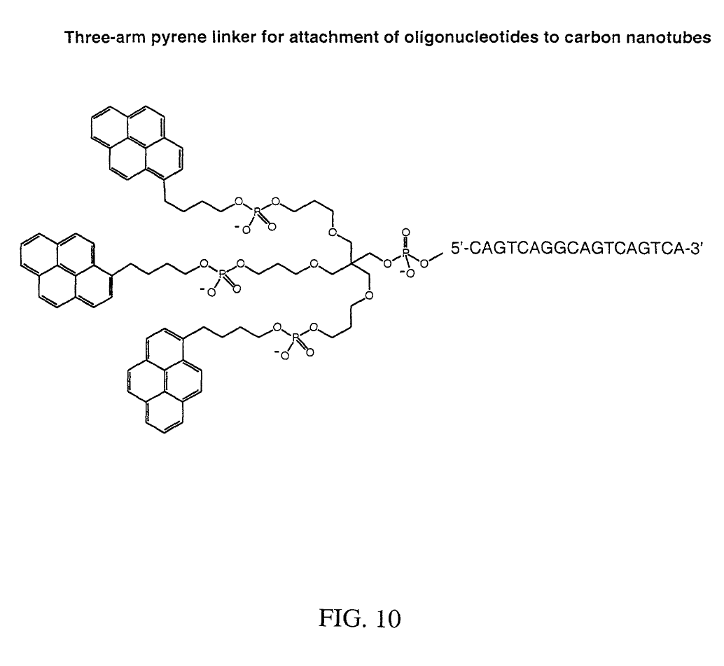

FIGS. 8-10 show some preferred biolinking molecules including multi-arm spacers. These spacers were developed as additional aspects of the present invention.

For the synthesis of biolinks such as those shown in FIGS. 8-10, oligonucleotide synthesis is preferably accomplished on an automated synthesizer with commercially available phosphoramidites and reagents. Synthesis is initiated on a controlled pore glass support. The appropriate phosphoramidites are then coupled sequentially to the support depending on the sequence desired. A trebler phosphoramidite is then coupled to the oligonucleotide thus providing the three-arm branch point. Subsequently a dithiol modifier phosphoramidite is coupled to each of the three ends of the trebler. Synthesis is concluded with the coupling of a thymidine residue followed by a C5-biotin labeled thymidine residue. Oligonucleotides are cleaved from the controlled pore glass support and deprotected with base and the solution evaporated to dryness.

The dried oligonucleotide is redissolved in a buffered aqueous solution containing 20 mM phosphate and 100 mM sodium chloride. The solution is loaded on to a column containing a neutral avidin-labeled support. Oligonucleotides that have successfully undergone a complete synthesis bear a biotin label at the 5′-end and bind to the avidin on the column. Failed syntheses lack the biotin label and pass through the column. Sequences bound non-specifically are washed away from the column with water. The column is then treated with a 20 mM phosphate, 100 mM sodium chloride, 150 mM dithiothreitol buffer. The dithiothreitol reduces the disulfide linkages within the oligonucleotide that were incorporated as the dithiol modifier phosphoramidite. The oligonucleotide bearing a terminal 5′ three-arm thiol linker is thus eluted from the column while the biotin tag and attached thymidine residues are retained on the column. The resulting oligonucleotide solution is then desalted and excess dithiotreitol removed either with C18 cartridges (Waters Sep pak cartridges) or by ethanol precipitation. Final oligonucleotide concentration is determined by UV spectroscopy at 260 nm.

3. Preparing the Substrate.

The substrate (and/or interconnect) is preferably prepared using standard microelectronic processing techniques. The substrate can be virtually any material (glass, quartz, plastic, metal, silicon, etc.), as long as it is able to have sites engineered on it for bonding the “free” end of the biolink molecule.

The substrate can be patterned with sites. These sites can be another “flavor” of metal (Au, Ti, Ni, etc.) or may have one or more other biolinking molecules attached. The substrate sites will attract the molecules in the solution and be bound to the site. Once the electron device is close to the substrate (within the molecule(s) length) it will bond to the site via electrostatic or hydrogen bonding.

The sites on the substrate are designed such that the device will “line up” or be mounted in the desired orientation (i.e., bond to the correct “pads” for electrical operation, source to source, gate to gate, etc.)

It is to be appreciated that the substrate can be “pre-wired” and patterned with sites, and the electron devices can be “flip chip” bonded, and wired up with a post bonding process (armed, metal, etc.)

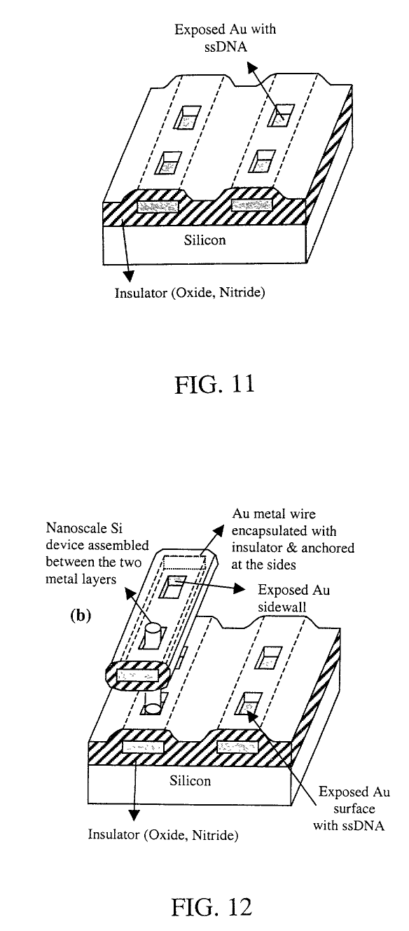

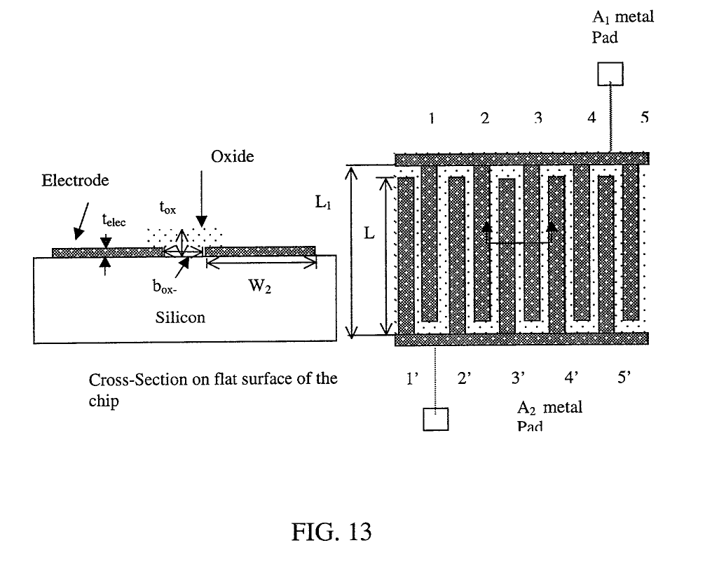

In one preferred embodiment oxidized wafers may be used as insulating substrates and layers of Au may be deposited and defined using e-beam lithography. These layers can be in the same level for planar 2-dimensional assembly as shown in FIG. 11. Alternatively, interconnects which are different distances away from the substrate can be fabricated so that assembly in the third dimension is realized as shown in FIG. 12.

In the case of 3-dimensional assembly, plasma deposited insulator films (oxide or nitride) may be used as the sacrificial interlayer dielectric which can be removed after the interconnect patterning.

The substrate may be provided with a charge to assist in attracting the nano-scale objects to the substrate. For example, a positive charge can provided by an electric field around the binding sites (electrodes) to attract negatively charged objects (e.g., DNA phosphate groups along the backbone are negatively charged.)

4. Attaching the BioLink to the Substrate.

A method similar to that described above is also used to attach the second biomolecule to the substrate. For example, exposed Au may be functionalized with ssDNA using sulfohydrol/thiol attachment. Voltage bias dependent attachment may also be used.

### EXAMPLE 7

### Attachment of DNA on Gold Surfaces

Substrates with patterned gold surfaces are broken into approximately 3X3 mm chips. Each chip is cleaned with acetone and DI water, and then dried with N₂. Attachment begins by placing a chip in a vial with 200 μL of 12 μM DNA in water and allowing this to incubate for 12 hrs. After which 50 μL of a 5X phosphate buffer is added to the vials and this is again allowed to incubate for 24 hrs. The samples are then rinsed in 0.3M phosphate-saline buffer and viewed under a fluorescent microscope to insure attachment has occurred.

5. Assembling the Construct.

After the first biolink has been attached to the nano-scale object, and the second biolink has been attached to the substrate, the two pieces must be positioned close enough together for the biolink to work. One method of doing that is to provide both pieces in solution and let the random motion of the particles bring them into close proximity.

Another method for bringing the two pieces together is to use electrostatic forces to cause the two pieces to attract. For example, the biolinks may be charged particles (such as strands of DNA) that may be manipulated with an electric field. Alternatively or additionally, plasma charging may be used to apply a charge to the object, thus allowing the object to be maneuvered over the substrate.

Since some biolink molecules such as DNA have charge associated with them, the biolink molecule may be used to provide the charge necessary to maneuver the object. In one embodiment, a charged biolink molecule such as DNA is attached to both the object and to the substrate, and the charged biolink molecule is used both to assist in maneuvering the object and to link the object to the substrate.

In another embodiment a charged molecule such as DNA is provided only on the object, and is used to assist in object positioning. Uncharged biolinks such as biotin and avidin are used to link the object to the substrate in this embodiment.

In a third embodiment the object to be attached in not provided with any charged molecule at all, but is charged with another technique such as plasma charging. In this embodiment uncharged biolinks such as biotin and avidin are provided on both the object and the substrate, and are used to link the object to the substrate.

In all three cases an electric field is preferably used to bring the object close enough to the substrate that the linking action (e.g., hydrogen bonding) of the biolinks can complete the attachment. An example of the electrostatic positioning that may be used to maneuver the object over the substrate is provided below.

### EXAMPLE 8

### Electrostatic Positioning

The positioning of small objects that are charged, using electrostatic forces is shown below. The objects used were 5.26 μm diameter polystyrene beads that are negatively charged.

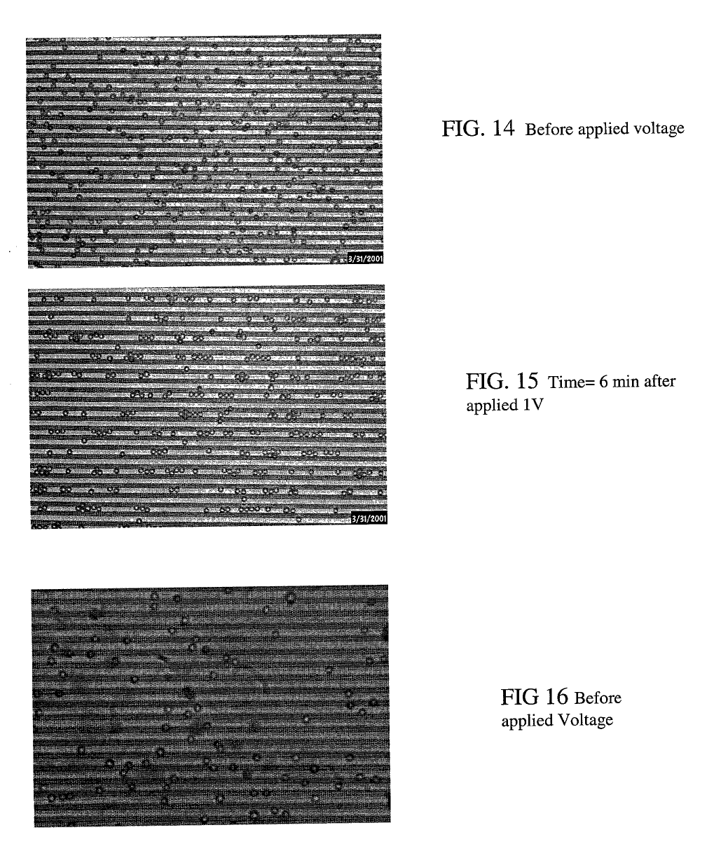

FIGS. 14-20 show some of the results. In FIGS. 14-16, a 1V current is applied to positively charged electrodes (5 μm width). FIG. 14 shows the beads and electrodes before the current is applied. FIG. 15 shows the assembly/collection of the beads on the positively charged electrodes 6 minutes after the current is applied. The beads have collected around alternating electrodes, i.e., around the positively charged electrodes.

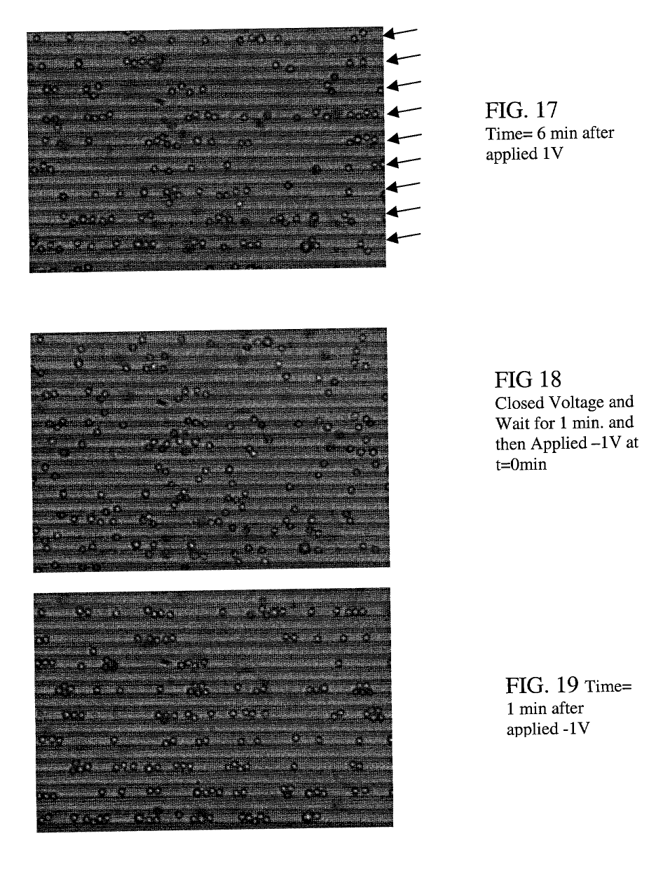

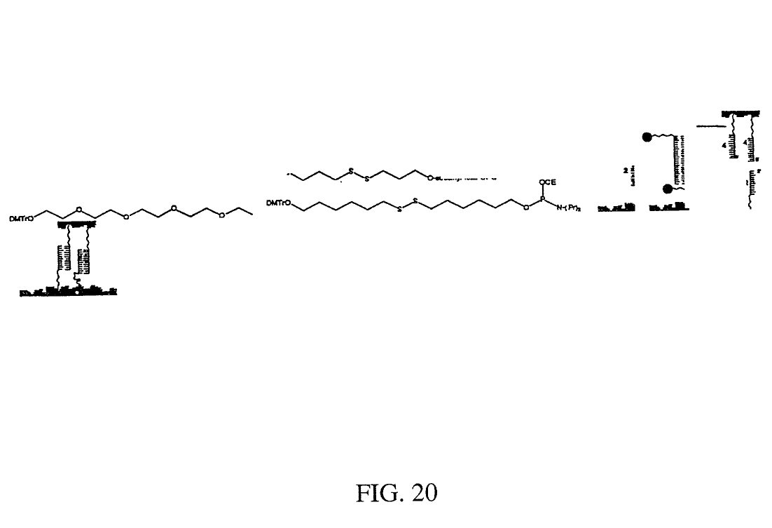

FIGS. 17-20 show a similar test, but with the current being applied and subsequently reversed. FIG. 17 shows the beads and electrodes before the current is applied. FIG. 18 shows the assembly/collection of the beads on the positively charged electrodes 6 minutes after the current is applied. The beads have collected around alternating electrodes, i.e., around the positively charged electrodes. FIG. 19 shows the system after the current is stopped, and FIG. 20 shows the system after the current is reversed. Note that the beads assemble around the alternating electrodes.

After the two pieces are close enough for the biolinks to bind, the assembly is completed by that action. In the most preferred embodiments the biolinks are single, complementary strands of DNA, and the process proceeds through hybridization of those DNA strands.

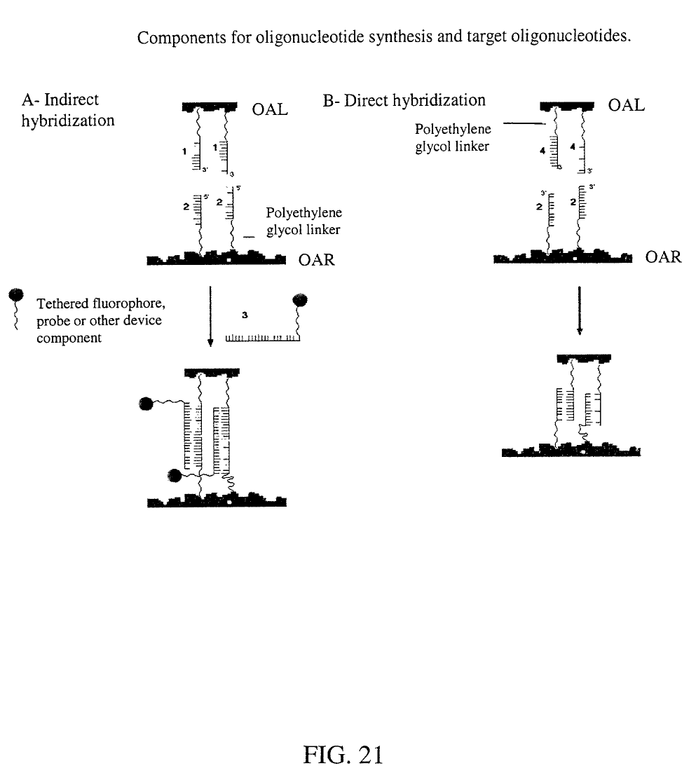

In some embodiments the link between the two biolinks is indirect, such as when a third strand is used to link two other strands. A diagram showing both direct and indirect hybridization is shown in FIG. 21.

### EXAMPLE 9

### Hybridization of DNA on Gold Surfaces

Hybridization can then be performed on the same chip. The chip is placed into a 200 μL 12 μM solution of the DNA hybridization sequence in a phosphate and NaCl buffer. This is then placed in a water bath at 72° C. for 10 min. The water bath with vials is allowed to cool slowly to room temperature. After 24 hrs, the samples are rinsed in 0.3M phosphate-saline buffer and viewed under a fluorescent microscope.

Spacers of different lengths may be introduced during the course of the automated oligonucleotide synthesis using molecules such as an 18-atom polyethylene glycol spacer, which is commercially available as a phosphoramidite (Glen Research). Each 18-atom polyethylene glycol spacer, when extended, adds 2.25 nm in length. Since hybridization of all (or even a majority) of the oligonucleotides is generally not necessary to achieve a stable linkage between the OAR and OAL, and since some of the oligonucleotides are attached at high elevations on the surfaces, a long (e.g., about 25 nm) spacer is generally not required.

The theoretical coverage of thiols on a gold surface has been calculated to be 0.77 nmol/cm² (4.6×1013 molecules/cm²). For OAL's of size 100 nm x 100 nm (10⁴ nm²=10⁻¹⁰ cm²) one can then estimate a coverage of the order of 4600 molecules. DNA duplexes pack in crystal structures with the helix axes separated by 2.8 nm. This is equivalent to 1250 vertically stacked helices per 104 nm² of surface. Since the oligonucleotides will be linked by long polyethylene glycol tethers it may well be possible to accommodate more than 1250 helices in the space between the OAL's and OAR's.

Control experiments show that the oligonucleotides are successfully covalently linked to the gold surfaces. This is accomplished by hybridizing a complementary sequence containing a fluorophore to the oligonucleotide conjugated surface and visualizing by confocal microscopy. Oligonucleotides containing a 5-fluorescein are constructed from commercially available fluorescein phosphorarnidite (Glen Research).

The system is then slowly cooled beginning above the Tₘ of the duplex (typically >60 *C) and continuing down to room temperature. This allows equilibrium mating of surfaces that contain the greatest number of duplexes. Hybridization will typically be done in a conventional aqueous 0. 1M phosphate buffer at pH 7-7.5.

Two strategies for linking the OAR and OAL by hybridization are illustrated in FIG. 21. In FIG. 21(A), the OAR (on substrate) and OAL (on devices) contain non-complementary sequences (1 and 2). A third oligonucleotide (3), which is complementary to both oligonucleotides 1 and 2 links the system together on hybridization. One advantage of this strategy is that the third oligonucleotide can be derivatized to carry a fluorophore, probe, or other entity that plays an integral role in the function of device.

In FIG. 21(B), the strategy of direct hybridization of complementary oligonucleotides attached to the OAL and OAR is shown. Both strategies have been employed to assembly nanoparticles.

One goal of the present invention is to provide techniques for linking devices asymmetrically. Consider construction of a bridge between two conductors. If one of the conductors is composed of platinum and the other gold, then it should be possible to selectively attach different oligonucleotide sequence to each metal through either a disulfide (gold specific) or isocyanide (platinum specific) terminated tether. This orthogonal self-assembly strategy was developed by Eckman et al. to selectively attach two different ferrocene molecules to gold and platinum surfaces. The bridge would be fabricated so that one end is gold capped and the other platinum capped. Different oligonucleotides would be attached to the gold and platinum caps so that each cap could be mated to a specific conductor on the devise. This is an example of a chemistry-mediated orthogonal self-assembly strategy. The major drawback to this approach is the need to develop a bifunctional linker containing an isocyanide group in combination with a functional group that can be linked in aqueous solution to an oligonucleotide.

An approach complementary to the orthogonal chemistry strategy is to construct asymmetric docking sites matched to asymmetric devices. Accordingly, in another aspect of the present invention two different shapes are tethered to the same oligonucleotides and are made to selectively associate. This is tantamount to site-specific delivery in biological systems.

Verification of oligonucleotide linkage to the OAR and the OAL can be done by hybridizing complementary fluorescein labeled-oligonucleotides to the surfaces and imaging by confocal microscopy. Further, buffer composition and concentration as well as cooling rate can be varied and compared by measuring fluorescence intensity. Verification studies typically require two 12-mer sequences corresponding to the two ends of 24mer oligonucleotide 3, but with a fluorescein conjugated to the 5′-end.

For the case of a rod or bar shaped device, the docking and assembly can also be verified electrically. Current-voltage measurements between two parallel conductors, with the device orthogonally assembled, indicate that the device connected to the interconnects.

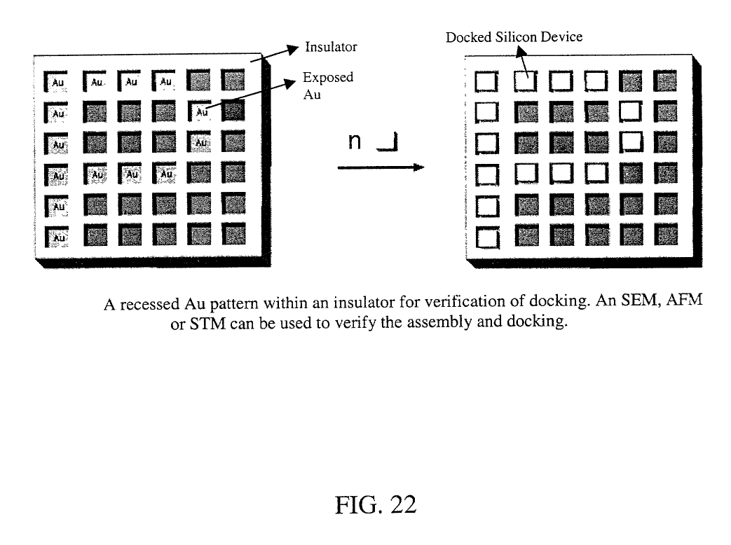

FIG. 22 shows a recessed gold pattern within an insulator, as prepared for verification of docking. As described above, SEM, AFM, and/or STM techniques all may be used to verify assembly and docking.

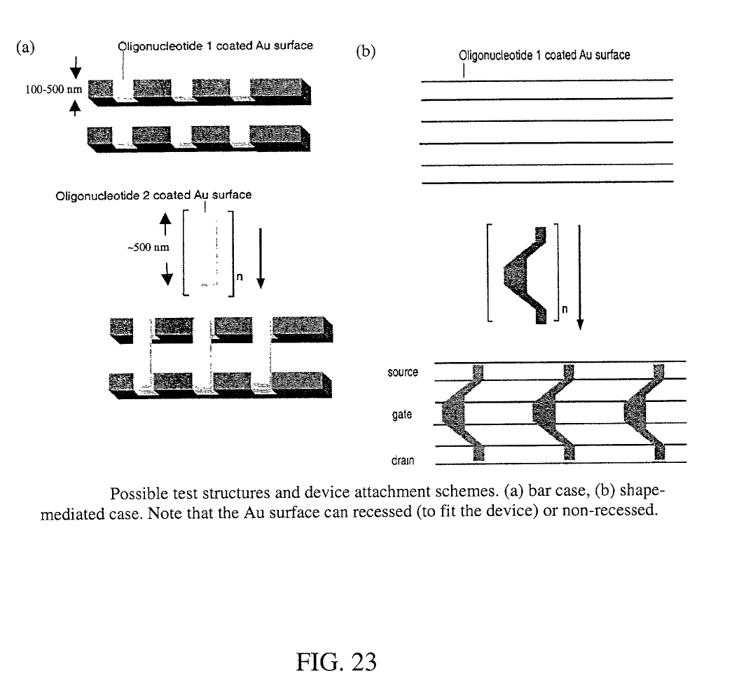

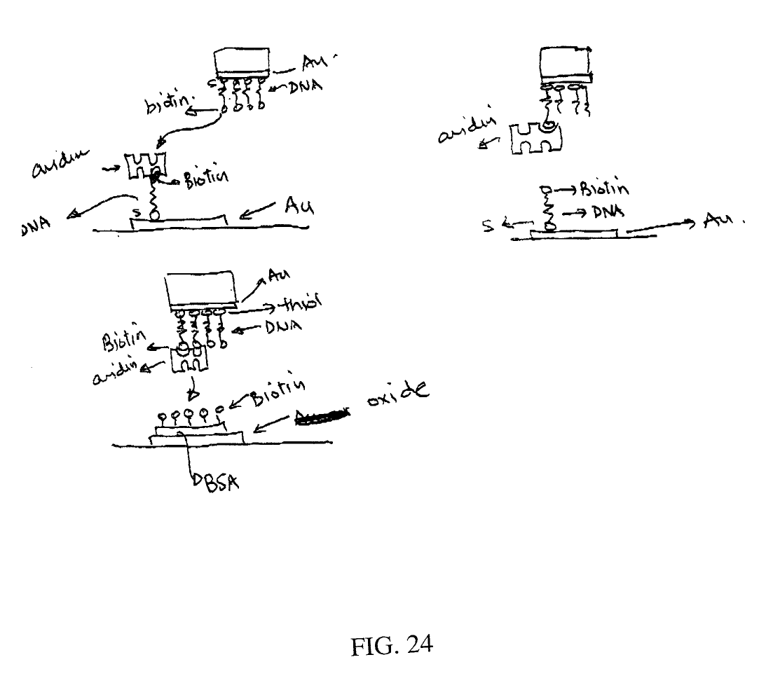

A variety of test structures and experiments can be performed to study the self-assembly (affinity-mediated and shape-mediated) of the silicon devices. FIG. 23 shows some of these concepts. The docking of bar shaped silicon devices across two exposed Au regions (recessed and non-recessed can be examined as shown in FIG. 23(a) (flat/flat bar). For the case of the rod-shaped devices, docking into exposed Au regions can also be examined (round/flat rod). Finally, the assembly of asymmetric shapes can also be verified. In this case, affinity binding will only take place when the devices are in close proximity to the oligonucleotide on the Au surface on the substrate. Three terminal devices can potentially be assembled into its contact regions.

Whatever process is used to assemble the constructs, the process can be repeated with new sites fabricated on the substrates (after the first bonding) and additional or different electron devices can be bonded in a second pass. Accordingly, different types of electron devices can be mixed and provided on the substrate. For example, on a first run n-channel MOSFETS can be applied, on a second run p-channel MOSFETS. On a third run BJTs, and on a fourth run passive devices like RLCs.

In another preferred embodiment a series of objects is bound to the substrate at different sites. The different objects may be provided with different “flavors” of biolinking molecules, metals, etc., and the different bonding sites are similarly prepared with different biolinks. Then, the different objects (MOSFETs (P&N) BJT, DLODES, R,C,L, etc.) are attached to the desired bonding sites, selectively. This requires only a single bond step after all of the objects are attached.

The attraction process of the device to the substrate can be “assisted” via “outside” sources and not 100% reliant on molecule to molecule “attraction”. The outside source may be electromagnetic fields (voltage, current bias, magnetic or electronic fields, buffering agent, catalysts, etc. The outside source may be required to accelerate the bonding process, control selectivity, enhance or assist in the attraction process, etc.

The substrate does not need to be “pre-wired.” The devices may be bonded “face up” and then all the devices can be “wired” after bonding.

The bonded material is not limited to silicon electron devices. The bonded material may be any electron or non-electron device (the LED's, lasers, GaAs device, GaN, III-V, II-VI, materials). The material may also be another chemical or biological material, such as cells, bacteria, viruses, etc.

In an alternative embodiment, an array of nano-scale devices is formed in the top silicon layer of an SOI substrate. Subsequently, a grid is patterned and etched in the silicon layer, with the devices at the intersections of the grid. Stress relief anchor points are provided by etching techniques in the silicon regions that connect the various devices. The underlying oxide layer is completely etched away to release the entire grid from the substrate. Linking biomolecules are preferably attached to the separate devices, and the entire grid is then placed on the desired substrate and the substrate. The substrate is flexed to separate the objects from the substrate.

6. Post-Assembly Processing.

After the object has been assembled onto the substrate, the construct is preferably annealed. This destroys the biomolecules that were the linking agents, and forms the metal-to-metal bond between the object and the substrate.

The annealing is preferably done at temperatures that do not damage the substrate or the metal interconnects. For example, temperatures of less than about 150° C. are preferably used for plastic substrates, while temperatures of up to 500° C. may be used for metal substrates. Lastly, it is to be appreciated that interconnects may be provided at the top of the assembled devices.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. Additional disclosure relating to some embodiments is contained in U.S. patent application Ser. No. 60/210,696, all of which is incorporated herein by reference.

What is claimed is:

1. A method of assembling a nanometer-scale construct, said method comprising:
(a) fabricating a nanometer-scale active electronic device;
(b) attaching a first bio-link to said nanometer-scale active electronic device to form a functionalized nanometer-scale active electronic device;
(c) providing a substrate;
(d) attaching a second bio-link to said substrate to form a functionalized substrate, wherein said second bio-link is a complement to said first bio-link in that said second bio-link selectively binds with said first bio-link; and
(e) bringing said functionalized nanometer-scale active electronic device within close enough proximity of said functionalized substrate that said second bio-link selectively binds with said first bio-link, and thereby forms an assembled nanometer-scale construct.

2. The method of claim 1 wherein said nanometer-scale object is a fabricated electronic device is a semiconductor device.

3. The method of claim 2 wherein said fabricated electronic device is fabricated by:
(a) etching a plurality of nanometer-scale islands on a substrate in a manner in which each island is held on the substrate by an unetched connector pillar having an aspect ratio of less than 1.0;
(b) agitating the connector pillars for a time sufficient to break the pillars and free the islands from the substrate.

4. The method of claim 3 wherein said substrate comprises a bonded etched-back Silicon-on Insulator material.

5. The method of claim 4 wherein said substrate comprises a photo resist layer on a bonded etched-back Silicon-on-Insulator material.

6. The method of claim 5 wherein said substrate comprises a thin metal film on a photo resist layer on a bonded etched-back Silicon-on-Insulator material.

7. The method of claim 3 wherein said unetched connector pillar comprises unetched oxide.

8. The method of claim 3 wherein said agitating step is performed by ultra-sonic agitation.

9. The method of claim 1 wherein said first biolink molecule also provides a charge to assist in electrostatic positioning of the nanometer-scale active electron device over the substrate.

10. The method of claim 1 wherein said first biolink molecule is biotin.

11. The method of claim 1 wherein said second biolink molecule is avitin.

12. The method of claim 1 wherein said first biolink molecule is a molecule of the formula:

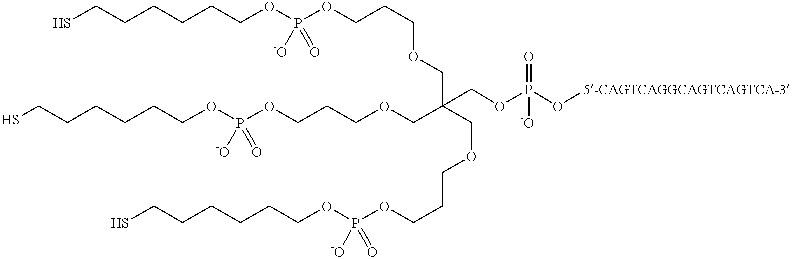

13. The method of claim 1 wherein said first biolink molecule is a molecule of the formula:

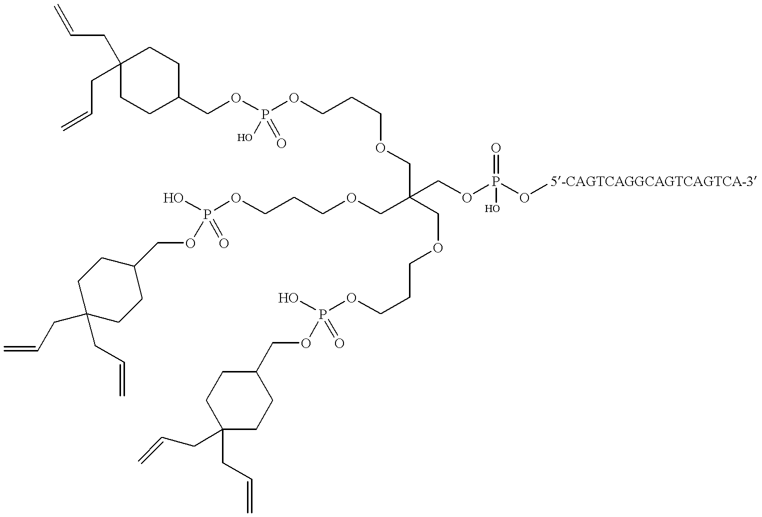

14. The method of claim 1 wherein said first biolink molecule is a molecule of the formula:

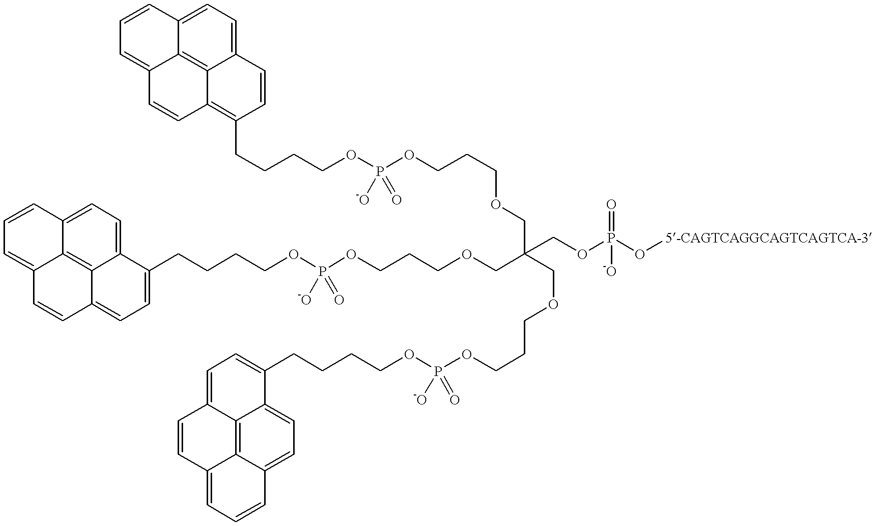

15. A method of claim 1 wherein said fabricating step comprises fabricating a grid of nanometer-scale active electron devices; wherein said first attaching step comprises attaching a first bio-link to each of the nanometer-scale active electron devices on said grid to form a grid of functionalized nanometer-scale active electron devices; wherein said second attaching step comprises attaching a plurality of second bio-links to said substrate to form a multi-functionalized substrate, and further including separating the assembled devices after the entire grid has been assembled.
